(19) United States
(12) Patent Application Publication
(10) Pub. No.: US 2013/0298386 A1
(43) Pub. Date: Nov. 14, 2013

(54) METHOD FOR PRODUCING A LITHIUM OR SODIUM BATTERY

(71) Applicants: Jean-Marie Tarascon, Mennecy (FR); Michel Armand, Paris (FR); Shanmukaraj Devaraj, Amiens (FR); Sylvie Grugeon, Fequieres (FR); Stephane Laruelle, Saveuse (FR)

(72) Inventors: Jean-Marie Tarascon, Mennecy (FR); Michel Armand, Paris (FR); Shanmukaraj Devaraj, Amiens (FR); Sylvie Grugeon, Fequieres (FR); Stephane Laruelle, Saveuse (FR)

(73) Assignees: UNIVERSITE DE PICARDIE JULES VERNE, Amiens (FR); CENTRE NATIONAL DE LA RECHERCHE SCIENTIFIQUE, PARIS (FR)

(21) Appl. No.: 13/704,418

(22) PCT Filed: Jun. 16, 2011
(86) PCT No.: PCT/FR11/51374

§ 371 Date: Jun. 21, 2013

(30) Foreign Application Priority Data
Jun. 17, 2010 (FR) 1054804

(51) Int. Cl. H01M 4/139

(52) U.S. Cl. CPC H01M 4/139
USPC 29/623.1

(57) ABSTRACT

The invention relates to a method for producing a battery using A⁺ (Li⁺ or Na⁺) as an electrochemical carrier, as well as to the resulting batteries. The method involves assembling together a negative electrode, a positive electrode, and an electrolyte, and then exposing the assembly to a firm charge at the operating temperature of the battery. The electrolyte is a ceramic or a solution of an A⁺ salt in a polar liquid, a polymer, or the mixture thereof. The active material of the negative electrode is a material which has a redox couple, the potential of which is 0 V to 1.6 V relative to the A⁺/A⁺ couple. The active material of the positive electrode is a material which has a redox couple, the potential of which is higher then that of the couple of the negative electrode. The positive electrode used during assembly consists of a current collector having a comprises material which contains the positive active material and at least one sacrificial salt of a cations E⁺ is selected from among Li⁺, Na⁺, K⁺ and the onium cations, and a redox action selected from azide anions, ketocarboxylate anions, and hydrazide anions, optionally in the form of a polymers.

The present invention relates to a method for producing a battery using lithium ions or sodium ions as electrochemical vector, and to the batteries obtained.

There are batteries known called lithium-ion batteries that use a carbon derivative at the negative electrode. The carbon derivative may be a “hard carbon”, containing primarily sp² carbon atoms, a “soft carbon” containing primarily sp³ carbon atoms, or an intermediate variety of carbon in which there coexist variable proportions of sp² carbon atoms and sp³ carbon atoms. The carbon derivative may also be a natural graphite or an artificial graphite, optionally covered with ungraphitized carbon which protects against exfoliation during electrochemical operation. The major drawback of these materials is the consumption of a part of the current, and hence of lithium ions originating from the positive electrode, during the first charge, the result of this being the formation on the negative electrode of a protective layer, called passivating layer (or SET layer), which prevents subsequent reaction of the electrolyte on the negative electrode into which the lithium is inserted. This phenomenon gives rise to a decrease in the energy density of the battery, since the lithium rendered unusable is withdrawn from the positive-electrode material, which has a low specific capacity (90-210 mAh·g⁻¹). In practice, between 5% and 25% of the initial capacity is lost in this way.

Studies have been carried out into other negative-electrode materials, such as silicon or tin, which readily form alloys with lithium. In theory, these alloys have very high capacities (≈2000 mAh·g,⁻¹ for Li—Si); however, during operation of the battery containing them as electrode material, they undergo considerable changes in volume (+400%). This variation in volume gives rise to fragmentation of the material and the exposure of a large surface area in contact with the electrolyte, and the formation of the passivating layer on the negative electrode requires from 25% to 40% of the initial capacity. Studies have also been carried out into alloys which, as a negative electrode, operate on an “extrusion” principle, such as Cu₃Sb, for example. When this alloy is used, during discharge, the lithium displaces the copper in accordance with the reaction 3Li⁺ 3e⁻+Cu₃Sb [symbol] 3 Cu⁰+Li₃Sb, thus forming an SET passivating layer and irreversibly immobilizing, in the negative electrode, from 15% to 35% of the lithium initially present in the positive electrode.

Also known is the use as negative-electrode material of transition metal fluorides, oxides, sulfides, nitrides, or phosphides, or of lithium and transition metal fluorides, oxides, sulfides, nitrides, or phosphides, said transition metals being selected from T^{M}═V, Cr, Mn, Fe, Co, Ni, Cu, and Zn, By reaction with the lithium, these materials form a two-phase system comprising the metal T^{M} and, respectively, LAI', Li₂O, Li₂S, Li₃N, or Li₃P, in the form of a mixture of particles having nanometric sizes. These reactions are called “conversion” reactions and exhibit a substantial capacity (400 to 800 mAh·g⁻¹). The low size of the grains in the two-phase mixture formed endows this reaction with a certain reversibility, since transport by diffusion/migration need be ensured only over distances of a few nanometers. However, the electrodes of this type, whose design and implementation are simple, have the drawback of an irreversible first-cycle capacity of 30% to 45%, thereby inhibiting their commercial development.

Research has been carried out into means of compensating this loss of lithium, which in practice diminishes the energy density, since it is technically not possible to remove the fraction of positive-electrode material which has served to form the passivating layer, said fraction remaining as a dead weight during the subsequent operation of the battery. The compound LiₓMn₂O₄ is a compound which is known as a positive-electrode material and has an operating range of 0≦x≦1, where x is 1 in the starting compound. Chemical treatment, by LiI for example, produces the stoichiometric compound Li₂Mn₂O₄. It is therefore possible, by preparing mixtures with a predetermined composition (1-α)LiMn₂O₄+(α)Li₂Mn₂O₄, to inject an additional quantity α of lithium into the electrode at the initial stage of a battery. However, this method is specific to the compound LiₓMn₂O₄, and the compound Li₂Mn₂O₄ obtained after chemical treatment does not exhibit sufficient guarantees of safety for the production of large-size batteries. Moreover, the structure of Li₂Mn₂O₄ is very different from that of LiMn₂O₄, owing to the Jahn-Teller distortion inherent to the Mn³⁺ ion, which is the majority ion in Li₂Mn₂O₄. The transition from the LiMn₂O₄ structure to that of Li₂Mn₂O₄ by chemical lithiation gives rise to crumbling of the grains, which promotes the dissolution of the manganese in the electrolyte and a loss of contact of the subdivided grains with the carbon (which is generally present in electrode materials as an electron-conducting agent). Electron exchanges between the oxide grains and the carbon are more limited as a result, thereby reducing the cycling lifetime of the battery.

Proposals have also been made to add dispersions of lithium in a nonreactive solvent, such as a hydrocarbon, said dispersions being stabilized by surfactants such as long-chain (stearic) fatty acids. These dispersions have to be added in a metered way at the surface of the negative electrode or of the positive electrode before the last step in manufacture of the battery, namely before the assembling of the electrodes. It is, however, very difficult to meter precisely the amounts of lithium added, and the handling of the suspensions is dangerous because of their flammability. In particular, the contacting of the metallic lithium with the positive or negative electrode material involves imposing a potential of 0 V vs, Li⁺/Li⁰, and this may destroy the electrode materials but may also make them sensitive to air and to moisture, in other words dangerous to handle. One of the principal advantages of the lithium-ion technology is specifically the possibility of manufacturing the generators in the discharged state, generally in a dry air atmosphere (“dry room”), without danger.

Sodium is employed for use in place of lithium in applications where the stored energy density is less critical than for portable electronics or automotive transport, more particularly for the management of renewable energies. Sodium only gives a more reduced number of insertion reactions, but, more particularly, Na₂FePO₄Fe and NaFeSO₄F are known, which are very inexpensive positive-electrode materials. The “hard carbons”, which can also be used as negative-electrode material, can give reversible Na⁺ insertions of the order of 200 mAh·g⁻¹, but here as well the formation of a passivating layer is necessary and represents a loss of 15% to 25% on the first cycle.

From EP-0 966 769 the addition is known of an alkali metal oxo carbon to the active material of a positive electrode in a battery which operates by circulation of lithium ions between the electrodes, for the purpose of at least partly remedying the loss in capacity during the 1st cycling, resulting from the formation of a passivating layer. However, during the 1st cycling of the battery, oxidation of the oxo carbon produces anion radicals which are soluble in an electrolyte, the effect of this being to degrade the negative electrode. There is indeed improvement in the initial capacity, but at the expense of the lifetime of the battery.

The aim of the present invention is to provide a battery which uses lithium ions or sodium ions as electrochemical vector, with its operation enhanced by reduction in the loss of capacity during the first discharge/charge cycle.

This aim is achieved by a method for producing a battery which operates by circulation of cations of alkali metal A, selected from Li and Na, between a positive electrode and a negative electrode, which are separated by an electrolyte, and in which:
the electrolyte is a material in which the cations A⁺ are mobile, selected from ceramics and solutions of a salt of A⁺ in a polar liquid, a polymer, or mixtures thereof;
the active material of the negative electrode is a material which possesses a redox couple whose potential is from 0 V to 1.,6 V relative to the A⁺/A⁰ couple, selected from the metal A, alloys and intermetallic compounds of the metal A, and materials capable of reversibly liberating cations A⁺;
the active material of the positive electrode is a material which possesses a redox couple whose potential is greater than that of the couple of the negative electrode, and which is capable, reversibly, either of inserting cations A⁺ or of reacting with the cations A⁺.

Said method involves assembling the negative electrode, the positive electrode, and the electrolyte, and then subjecting the assembly to a first charge at the operating temperature of the battery.

Said method is characterized in that the positive electrode used at assembly is composed of a composite electrode material and a current collector, said composite material comprising said positive-electrode active material and a “sacrificial salt” whose cation E⁺ is selected from Li⁺, Na⁺, K⁺, and onium cations, and whose anion is a redox anion selected from azide anions, ketocarboxylate anions, and hydrazide anions, optionally in polymeric form, said sacrificial salt having a redox couple at a potential greater than the potential of the negative-electrode active material redox couple.

The sacrificial salt is a compound capable of undergoing oxidation during the 1st charge-discharge cycle of the assembled battery, at a potential greater than the potential of the redox couple of the negative-electrode active material, preferably in the potential range of the redox couple of the positive-electrode active material—for example, in a potential range from 2.0 V to 4.6 V. On its oxidation, the sacrificial salt produces ions E⁺ which penetrate the electrolyte, while an amount of ions A⁺ corresponding to one equivalent charge passes from the electrolyte toward the negative electrode. Said ions E⁺ at least partly compensate the capacity lost during the formation of the passivating layer. The oxidate of the sacrificial salt also produces gaseous compounds which are easily removed, such as N₂, CO or CO₂, during the production of the battery. Indeed, during the construction of batteries, more particularly of lithium ion batteries, conventionally, the assembled electrodes and electrolyte are introduced into a casing, and the assembly is subjected to a first charge-discharge cycle which produces a gaseous discharge (even in the absence of the sacrificial salt of the present invention) and also produces a passivating layer by reduction of the electrolyte at the negative-electrode material, which operates at potentials of 1.6 to 0 V relative to the Li⁺/Li⁰ couple, and then the casing is sealed. If the casing remains open during the 1st cycle, the gases are removed at the rate at which they form, and then the casing is seated. If the casing is sealed during the 1st cycle, it is subjected to a partial vacuum after the 1st cycle in order to remove the gases formed, and then it is resealed.

Among the sacrificial salts in which the cation is an onium cation, preference is given more particularly to those which are liquid at standard temperature or at a temperature of less than 100° C. Among the onium cations, mention may be made more particularly of alkylmethylimidazolium, alkylmethyl-pyrimidinium, and alkyltrimethylammonium cations in which the alkyl groups have from 2 to 8 carbon atoms.

A potassium salt or an onium cation defined above for E⁺ may be used as sacrificial salt, although the potassium ions or said onium cations are not electrochemical vector ions in a battery according to the invention. The reason is that the potassium ions and said onium cations undergo reduction at a more negative potential than Li⁺ and Na⁺, and the deposition of Li or of Na may take place without interference of potassium ions or organic cations. Moreover, the onium cations are metastable at the deposition potentials of Li or of Na, or at the operating potential of the negative electrode. Moreover, a negative-electrode compound, selected from insertion materials (such as, for example, lithium titanates and graphites) and conversion materials (for example, oxides, fluorides, and sulfides), is selective for lithium or sodium ions for steric reasons. The effect of using a potassium salt or an onium cation salt is to enrich the electrolyte with cations other than A⁺, reducing the proportion of ions A⁺ already existing in the electrolyte.

The addition of the sacrificial salt during production of the battery therefore does not add any useless weight, since the cation E⁺ is useful and the anion of the sacrificial salt is removed in gaseous form.

The positive-electrode material used in the production of a battery according to the invention may comprise one or more sacrificial salts,

Compounds which can be used as sacrificial salt include more particularly those which are defined by the formulae below, in which A is Li or Na, and 3≦n≦1000. Each of the values indicated in mAh/g represents the specific capacity obtained in a lithium-ion battery when the additive is the lithium salt of the anion in question. It is clearly apparent that these capacities are largely greater than that of the positive-electrode materials (100-200 mAh·g⁻¹).

| Classes [symbol] | [symbol] Compounds [symbol] |
|---|---|
| Azides | 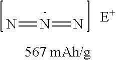 |
| Keyto- carboxy- lates | 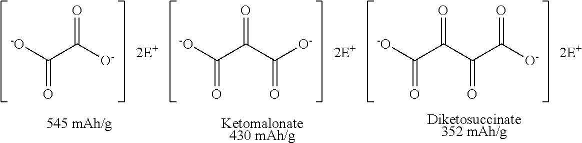 |
| Hydra- zides | 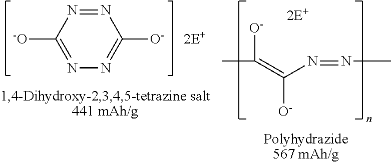 |

The method of the invention is useful for producing a battery which operates by circulation of ions A⁺, and in which the electrolyte comprises at least one salt of A in solution in a solvent.

The electrolyte used at assembly of said battery comprises at least one salt of A which is dissociable when it is in solution in a liquid or polymeric solvent.

The salt of A may be selected in particular from the salts of an anion corresponding to one of the following formulae: ClO₄⁻, BF₄⁻, PF₆⁻, AsF₆⁻, SbF₆⁻, SCN⁻, R_{F}SO₃⁻, [(R_{F}SO₂)NSO₂R′_{F}]⁻, [(R_{F}SO₂)C(Y)SO₂R_{F}′]⁻ in which Y is CN or SO₂R_{F}″, [R_{F}SO₂(NCN)]⁻, [R_{F}SO₂ {C(CN)₂}]⁻, 2-perfluoroalkyl4,5-dicyanoimidazole [R_{F}C₅N₄]⁻, 4,5-dicyano-1,2,3-triazole [C₄N₅]⁻, 2,5-bis(fluorosulfonyl)-1,3 -triazole [C₂F₂S₂O₄]⁻, and 3-cyano-5-perfluoroalkyl-1,3,4-triazole [R_{F}C₃N₄]⁻, where R_{F}, and R_{F}′, are R_{F}″ alkyl groups in which at least 60% of the hydrogen atoms are replaced by fluorine atoms.

After the first charge-discharge cycle of the assembled battery, the electrolyte also includes a salt of the cation E⁺. The cations E⁺ originate at least partly from the sacrificial salt which is present in the positive-electrode material during production of the battery. The cations E⁺ may also originate from a salt of E⁺ which is added to the material intended for forming the electrolyte during its production.

The solvent of the electrolyte of a battery which operates by circulation of lithium ions may be a liquid solvent which is optionally gelled by addition of a polymer, or a polymeric solvent which is optionally plasticized by a liquid solvent.

A liquid solvent may be composed of at least one polar aprotic solvent selected, for example, from cyclic and linear carbonates (for example, ethylene carbonate, propylene carbonate, butylene carbonate, dimethyl carbonate, diethyl carbonate, dipropyl carbonate, ethyl methyl carbonate, vinylene carbonate, cyclic ethers (for example, THF), polyethylene glycol ethers RO(CH₂CH₂O)R′ in which IR and R′ are CH₃ or C₂H₅ and 1≦n≦12, tetraalkyl sulfarnides RR′NSO₂NR″R″′ in which R, R′, R″, and R″′ are CH₃ or C₂H₅,3-meth 4-1,3-oxazolidin-2-one, and cyclic esters (for example, γ-butyrotactone).

A liquid solvent may be composed of an ionic liquid, selected for example from salts having a cation selected from cations E⁺ of the onium type and an anion selected from the anions of the abovementioned lithium salts. It is particularly advantageous to use an ionic liquid type solvent, selected from the salts of organic cations which can be used as sacrificial salts. In this case, the change in relative concentrations in the electrolyte between the ions A⁺ and the ions E⁺ is low, owing to the very high concentration of E⁺ ions, namely from 5 M to 15 M.

Said liquid solvent (aprotic polar liquid or ionic liquid) may optionally be gelled by addition of a polymer obtained, for example, from one or more monomers selected from ethylene oxide, propylene oxide, methyl methacrylate, methyl acrylate, acrylonitrile, methacrylonitrile, and vinylidene fluoride, said polymer having a linear, comb, random, alternating, or block structure, and being crosslinked or not. A polymeric solvent is composed, of a solvating polymer, for example, a poly(ethylene oxide) or a copolymer containing at least 50% of repeating units —CH₂CH₂O— and having a linear, comb, random, alternating or block structure, and being crosslinked or not. Said polymeric solvent may optionally be plasticized by addition of a liquid, more particularly a polar aprotic liquid which can be used as a solvent for a liquid electrolyte.

In a 1st embodiment of a battery which operates by circulation of ions A⁺ and in which the electrolyte is a solution of a salt of A⁺ in a solvent, the positive electrode is composed of a current collector which carries a composite electrode material. During production of the battery, the initial composite material, intended for forming the positive electrode, comprises at least one positive-electrode active material, an electron-conducting agent, at least one sacrificial salt, and optionally a binder. The amount of active material of said composite material is preferably from 5 to 95 weight %, the amount of electron-conducting agent is preferably from 0.1 to 30 weight %, the amount of binder varies preferably from 0 to 25 weight %, and the amount of sacrificial salt is preferably from 5 to 70 weight %. After the first charge, said composite material comprises the electrode active material, the electron-conducting agent, and the optional binder that were introduced initially.

The electron-conducting agent is preferably a carbon material, as for example carbon black, acetylene black, natural or synthetic graphite, carbon nanotubes, or a mixture of these compounds.

The binder of the positive electrode may be selected from the materials mentioned above as gelled liquid electrolyte or polymeric electrolyte. The binder may, moreover, be composed of a polymer, selected for example from ethylene- propylene copolymers optionally containing a unit which allows crosslinking, styrene-butadiene copolymers, more particularly in latex form, poly(tetrafluoro- ethylene) latices, and cellulose derivatives (for example, carboxymethylcellulose or hydroxyethylcellulose). In one particular embodiment, these polymers may contain a fraction of repeating units that are intended for increasing the adhesion of the polymer to the grains of active material, and/or to the current collector. Said repeating units may more particularly be units containing carboxyl groups, units derived from maleic anhydride, or phosphonic acid groups.

The positive-electrode active material capable of inserting sodium ions reversibly may be selected from:
the lamellar fluorophosphates Na₂TPO₄F in which T represents a divalent element selected from Fe, Mn, Co, and Ni, which may be replaced partially by Mg or Zn,
fluorosulfates NaT′SO₄F in which T represents at least one element selected from Fe, Mn, Co, and Ni, a part of which is optionally replaced by Mg, and a part of the sulfate groups SO₄²⁻ of which is optionally replaced by the isosteric and iso-charge group PO₃F²⁻;
polysulfides Na₂Sₙ(1≦n≦6), and sodium salts of dimercaptothiadiazole and of dimercaptooxazole;
dithiocarbamates Na[CS₂NR′R″] in which each of the groups R′ and R″ represents a methyl, ethyl, or propyl radical, or else R′ and R″ form a ring (for example, pyrrolidine or morpholine).

In one embodiment, the positive--electrode active material capable of inserting lithium ions reversibly may be selected from:
transition metal chalcogenides, more particularly oxides LiₓT^{a}O₂ in which 0≦x≦1 and T^{a} represents at least one element selected from Co, Ni, and Mn, a part of which may be replaced by Mg or Al;
phosphates of olivine structure LiₓT^{b}PO₄, 0≦x≦1, in which T^{b} represents at least one element selected from Fe and Mn, a part of which may be replaced by Co, Ni or Mg;
silicates Li₂T^{c}SiO₄ and fluorophosphates LiₓT^{c}PO₄F, in which T^{c} represents at least one element selected from Fe, Mn, Co, Ni, and Ti, a part of which may be replaced by Mg or Al;
fluorosulfates LiₓT^{d}SO₄F in which T^{d} represents at least one element selected from Fe, Mn, Co, and Ni, a part of which may he replaced by Mg and a part of the sulfate groups SO₄²⁻ of which may be replaced by the isosteric and iso-charge group PO₃F²⁻;
polysulfides Li₂Sₙ, 1≦n≦6, and lithium salts of dimercaptothiadiazole and of dimercaptooxazole.

In another embodiment of a battery operating by circulation of lithium ions, in which the electrolyte is a solution of a lithium salt in a solvent, the positive electrode is composed of carbon and optionally a catalyst (for example, MnO₂ in finely divided form). In this embodiment, the battery, called a lithium-air battery, operates by reaction between the oxygen in the air (acting as positive-electrode active material) and the negative-electrode lithium. The creation of porosity in the positive electrode (called “oxygen electrode”) during the decomposition of the sacrificial salt in the course of the first charge creates a porosity which promotes the penetration of the oxygen of the air into the battery, and, consequently, the reaction with the negative electrode. A positive electrode called “oxygen electrode” may be used in a battery comprising a lithium anode or lithium-alloy anode, or an anode comprising a lithium insertion material. The material used for producing the positive electrode comprises carbon, optionally the catalyst, and at least one sacrificial salt, preferably in the following proportions by weight: from 1% to 60% of carbon, from 5% to 95% of sacrificial salt, and from 0 to 20 of catalyst.

In a “lithium” battery, the negative electrode is a film of metallic lithium,

In a “lithium-ion” battery, the negative electrode consists of a current collector which carries a composite electrode material, comprising a negative-electrode active material, optionally an electron-conducting agent, and optionally a binder. The electron-conducting agent and the binder may be selected from those mentioned above for the positive electrode. The negative-electrode active material may be a material capable of inserting lithium ions reversibly. This material may in particular be a hard carbon having a “number of sp³ atoms/number of sp² atoms” ratio of the order of 20%, a soft carbon having a “number of sp³ atoms/number of sp² atoms” ratio of the order of 100%, a carbon of intermediate hardness, a natural or artificial graphite, or a lithium dicarboxylate (more particularly lithium terephthalate). The active material may also be a lithium alloy (for example, a silicon-lithium or tin-lithium alloy) or another intermetallic lithium compound (for example, the compound LiAl), optionally Mg-doped lithium titanate Li₄Ti₅O₁₂, or molybdenum dioxide or tungsten dioxide. When the negative-electrode material comprises an alloy of Li or an intermetallic lithium compound as active material, it necessarily includes an electron-conducting agent.

In a “sodium” battery, the negative electrode consists of metallic sodium, During the production of a battery in which the active material of the negative electrode is sodium metal, there is no need to introduce the sodium metal beforehand. Sodium in the 0 oxidation state will deposit on the current collector of the negative electrode during the 1st charge of the battery, by decomposition of a sodium compound added as sacrificial salt to the composite material used for producing the positive electrode, and by electrochemical reaction of the sodium salt of the electrolyte at the interface between the electrolyte and the current collector.

In a “sodium-ion” battery, the negative electrode consists of a current collector which carries a composite electrode material, comprising a negative-electrode active material, an electron-conducting agent, and optionally a binder, The electron-conducting agent and the binder may be selected from those mentioned above for the positive electrode. The negative-electrode active material is a material capable of inserting sodium ions reversibly. This material may in particular be a mesoporous carbon, a sodium dicarboxylate (more particularly sodium terephthalates, a sodium ferrite NaₓFeO₂, a sodium aluminum titanate NaₓTi₁₋ₓAl_{z}O₂ (0≦x≦1, 0≦z≦0.4) of lamellar structure, also denoted “hollandite”, or by a sodium alloy, for example a tin-sodium alloy or a lead-sodium alloy.

The method of the invention may additionally be employed for producing a battery which operates by circulation of sodium ions, in which the electrolyte is a ceramic.

The material used for forming the ceramic electrolyte during the assembly of the battery may be selected, for example, from β-alumina, β″-alumina, phosphosilicates of Nasicon structure, and glasses based on Na₂O and on at least one network-forming oxide selected from SiO₂, B₂O₃, and P₂O₅. The β-alumina capable of forming the electrolyte corresponds to the formula (11Al₂O₃+δNa₂O) (1≦n≦2).

After the first charge-discharge cycle of the assembled battery, the ceramic electrolyte additionally contains a salt of the cation E⁺. The cations E⁺ originate at least partly from the sacrificial salt which is present in the positive-electrode material during production of the battery. The cations E⁺ may also originate from a salt of the cation E⁺ that is added to the material intended for forming the second electrolyte during its production during the production of the battery.

The positive electrode of a ceramic-electrolyte battery may be composed of a mixture of active material and of a carbon material which acts as an electron-conducting agent deposited current collector.

The active material is selected from sulfur, sodium sulfides Na₂Sₙ (1≦n≦6), and dithiocarbamates Na[CS₂NR′R″] in which each of the groups R′ and R″ represents a methyl, ethyl, or propyl radical, or else R′ and R″ form a ring (for example, pyrrolidine or morpholine),

When the material of the positive electrode is solid during the operation of the battery, it is desirable to add a second electrolyte to the positive-electrode compartment, this second electrolyte consisting of a sodium salt in solution in a liquid or polymeric solvent, and being intended to improve contacts. The salt of the second electrolyte may be selected from sodium chloroaluminate NaAlCl₄ and sodium dithiocarbamates Na[CS₂NR′R″] in which each of the groups R′ and R″ represents a methyl, ethyl, or propyl radical, or else R′ and R″ together form a ring (for example, pyrrolidine or morpholine). These electrolytes operate above their melting temperature, between 100 and 300° C. When the second electrolyte contains a polymeric solvent, preference is given to a polymer containing at least 60% of units [CH₂CH₂O], in which the salt may be at least partly dissolved.

The carbon material of the positive electrode is preferably composed of carbon fibers or a carbon felt, which may also act as current collector,

The active material of the negative electrode is metallic sodium, on a current collector. The current collector of the negative electrode is preferably steel in a finely divided form (for example, steel wool), since this form makes it possible to limit the flow of sodium in the event of battery breakage, in particular of the ceramic forming the electrolyte.

One of the advantages of the invention lies in the simple use of sacrificial salts which are stable in the ordinary atmosphere or under the conditions employed during the manufacture of batteries which operate by circulation of lithium or sodium ions in an anhydrous atmosphere having a dew point of from 0° C. to −100° C.

For batteries other than “sodium-sulfur” ceramic-electrolyte batteries, another advantage of the invention lies in the fact that the oxidation of the sacrificial salt that takes place during the 1st charge of the battery creates a porosity in the composite material of the positive electrode, said material comprising, during assembly of the battery, the positive-electrode active material, the sacrificial salt, an electron-conducting agent, and optionally a polymeric binder. A controlled porosity is very important for ensuring rapid kinetics of electrodes, including sustained battery power. In the batteries according to the invention (other than the “sodium-sulfur” batteries), the space liberated by the disappearance of the sacrificial salt by oxidation is filled with the electrolyte, which acts as a reservoir for alkali metal ions, this reservoir being necessary owing to the impoverishment in the course of operation, which results from the mobility of the anions. The reason is that the balance of material in an electrolyte whose conduction is due both to cations and to anions, and whose electrodes exchange only Li⁺ and Na⁺ cations with the electrolyte, shows that the compartment of the positive electrode becomes impoverished in Li or Na salts. It is therefore necessary to have a substantial porosity, which is filled with electrolyte and is capable of supplying the required amounts of salt,

The present invention is illustrated in more detail in the examples below, it is not limited to said examples.

### EXAMPLE 1

In a rotary evaporator, a 20% aqueous solution of lithium azide, sold by the company Aldrich®, was evaporated to dryness, to give a colorless crystalline powder of LiN₃. In an agate mortar, 100 mg of LiN₃ were mixed with 30 mg of carbon SP, which is sold by the company TIMCAL).

In a Swagelok® electrochemical cell with a side passage for a reference electrode, a working electrode consisting of 10 mg of a mixture of LiN₃ (7,7 mg)+carbon (2.3 mg), a negative electrode consisting of metallic lithium, and a reference electrode consisting of a silver wire were mounted. As electrolyte, a commercial 1M solution of LiPF₆ in an ethylene carbonate/dimethyl carbonate mixture (50/50 by weight) was introduced. A constant current was applied to the cell (421 μA) between the working electrode and the counterelectrode, calculated so as to allow extraction of one lithium equivalent of the LiN₃+carbon mixture in ten hours. The change over time of the potential difference between the working electrode and the reference electrode (E_{we}−E_{ref}) was recorded, and it is shown by the curve a) in FIG. 1, in which E_{we}−E_{ref} (in V) is shown on the ordinate, and the time T (in hours) is given on the abscissa.

### EXAMPLE 2

A solution of 3,60 g of the sodium salt of mesoxalic acid (sold by the company Fluka) in 50 ml of 95% ethyl alcohol was admixed gradually with 1,96 g of pure sulfuric acid diluted in 5 ml of trifluoroethanol. The mixture was subsequently stirred for 4 hours and then centrifuged. The supernatant solution Obtained after centrifuging was admixed with 1.85 g of commercial lithium hydroxide monohydrate. In the absence of air, the mixture was kept with stirring for 24 hours, and then the milky solution was centrifuged and the product was washed with three times 20 ml of 95% ethanol, then dried under vacuum. This gave 2.72 g of lithium dihydroxymalonate Li₂[CO₂C(OH)₂CO₂] (yield: 92%), which was heated under reduced pressure at 150° C., causing a loss of mass of 22%, corresponding to the quantitative formation of the ketomalonate Li₂[CO₂COCO₂], in which the central C═O bond is visible in IR at 1530-1900 cm⁻¹.

100 mg of ketomalonate Li₂[CO₂COCO₂] were mixed with 30 mg of Ketjen Black 600®, and the mixture was ground together in a mortar for 5 minutes to give a homogeneous mixture.

In a Swagelok® electrochemical cell similar to that in example 1, a working electrode consisting of 1.95 g of said homogeneous mixture was mounted, and a constant current of 30.6 μA was applied to the cell between the working electrode and the counterelectrode, said current allowing the extraction of one lithium equivalent of the Li₂[CO₂COCO₂]+ carbon mixture in ten hours. The change over time of the potential difference between the working electrode and the reference electrode (E_{we}−E_{ref}) was recorded, and it is shown by the curve b) in FIG. 1.

### EXAMPLE 3

3.15 g of dihydroxyfumaric acid, sold by the company Aldrich®, were suspended in 25 ml of absolute ethanol, and 7.2 g of commercial pyridinium tribromide were added. The slightly yellow suspension thus obtained was admixed with 2.4 g of lithium acetate dehydrate. Following centrifugation, the suspension was washed with two times 25 ml of anhydrous ethanol, and then 2 g of lithium hydroxide monohydrate in 25 ml of 95% ethanol were added. In the absence of air, the mixture was subsequently kept with stirring for 24 hours, the milky solution obtained was centrifuged, and the product was washed with three 20 ml portions of 95% ethanol, and then dried under reduced pressure. This gave 3.3 g (85% yield) of lithium dihydroxytartrate Li₂[CO₂C(OH)₂C(OH)₂CO₂], which was heated under reduced pressure at 150° C., causing a loss of mass of 18%, corresponding to the quantitative formation of anhydrous Li diketosuccinate Li₂[CO₂C(═O)C(═O)CO₂], in which the central C═O bonds are visible in IR at 1530-1900 cm⁻¹.

100 mg of diketosuccinate Li₂[CO₂COCOCO₂] were mixed with 30 mg of Ketjen Black 600®, and the mixture was ground together in a mortar for 5 minutes to give a homogeneous mixture.

In a Swagelok® electrochemical cell similar to that in example 1, a working electrode consisting of 3 g of said homogeneous mixture was mounted, and a constant current of 40 μA was applied to the cell between the working electrode and the counterelectrode, said current allowing the extraction of one lithium equivalent of the Li₂[CO₂COCOCO₂]+carbon mixture in ten hours. The change over time of the potential difference between the working electrode and the reference electrode (E_{we}−E_{ref}) was recorded, and it is shown by the curve c) in FIG. 1.

### EXAMPLE 4

2.36 g of commercial oxalyl dihydrazide (CONHNH₂)₂ were suspended in 20 ml of propylene carbonate, and 3 ml of anhydrous pyridine were added. This suspension was admixed dropwise, with magnetic stirring, with 2.54 g of oxalyl dichloride diluted in 5 ml of propylene carbonate. A release of heat signals the formation of the polyhydrazide [CONHNHCO]ₙ in the form of a bright yellow suspension. The precipitate of polyhydrazide formed in the suspension is separated by centrifuging and then washed with 3×20 ml of water and then with 2×10 ml of ethyl ether, and dried under reduced pressure. In a glovebox under argon, 1 g of polymer [CONHNHCO]ₙ was suspended in anhydrous methanol, 1.2 g of lithium methoxide were added, and the suspension was held with stirring for 24 hours. The change in vivid yellow color observed corresponds to the formation of the polymer [CON(Li)N(Li)CO]ₙ, which is isolated by centrifugation and drying under a neutral atmosphere.

100 mg of polymer [CON(Li)N(Li)CO]ₙ were mixed with 30 mg of Ketjen Black 600®, and the mixture was ground together in a mortar for 5 minutes to give a homogeneous mixture.

In a Swagelok® electrochemical cell similar to that in example 1, a working electrode consisting of 3.3 mg of said homogeneous mixture was mounted, and a constant current of 68 μA was applied to the cell between the working electrode and the counterelectrode, said current allowing the extraction of one lithium equivalent of the [CON(Li)N(Li)CO]ₙ+carbon mixture in ten hours. The change over time of the potential difference between the working electrode and the reference electrode (E_{we}−E_{ref}) was recorded, and it is shown by the curve d) in FIG. 1.

FIG. 1 shows that the sacrificial salts used in examples 1 to 4 are active at their theoretical capacity

### EXAMPLE 5

In a first embodiment, 2.703 g of dibenzylcarbonyl hydrazide CO[N(CH₂C₆H₅)NH₂]₂ were reacted with 1.63 g of carbonyldiimidazole in acetonitrile, and then Raney nickel was introduced into the reaction mixture, which was subjected to an H₂ stream. This gave 1,4-dihydroxy-2,3,4,5-dihydrotetrazine. 1 g of 1,4-dihydroxy-2,3,4,5-dihydrotetrazine was suspended in 7 ml of pyridine, and 1 g of lithium bromide and 2.54 g of iodine were added. The lithium salt of 1,4-dihydroxy-2,3,4,5-tetrazine, which precipitated, was separated by centrifuging, washed with 5×10 ml of acetonitrile, and dried under reduced pressure.

In another embodiment (described by D. E. Chavez, M. A. Hiskey, R. D. Gilardi, Angew. Chem 2000, 112, 1861-1863; Angew. Chem. Int, Ed. 2000, 39, 1791-1793), 1 g of 1,4-dichloro-1,3,5,6-tetrazine C₂N₄Cl₂ was hydrolyzed using 1.35 g of lithium trimethylsilanoate in 5 ml of DMF. The precipitate formed was isolated by centrifuging, washed with 5×10 ml of anhydrous THF, and then dried.

For each of the samples of Li₂C₂O₂N₄ prepared in this way, a mixture of Li₂C₂O₂N₄ and Ketjen Black® was prepared, an electrochemical cell was produced in accordance with the procedure of example 1, and the cell was tested under the conditions of example 1. The specific capacity obtained at the final voltage of 4 volts vs. Li⁺/Li⁰ is 420 mAh/g, or 95% of the theoretical value.

### EXAMPLE 6

The lithium azide prepared according to the procedure of example 1 was tested as an additive in the positive electrode of a battery.

77.6 mg of LiMn₂O₄, 10 mg of Ketjen black® carbon, and 7.36 mg of lithium azide were mixed and were ground together in a mortar for 5 minutes,

20.7 mg of the homogeneous mixture obtained were applied to one end of an aluminum cylinder 50 mm in length. The electrode thus obtained was mounted in a Swagelok® electrochemical cell similar to that of example 1, in which the positive electrode is the working electrode and the counterelectrode is a lithium electrode and serves as reference electrode.

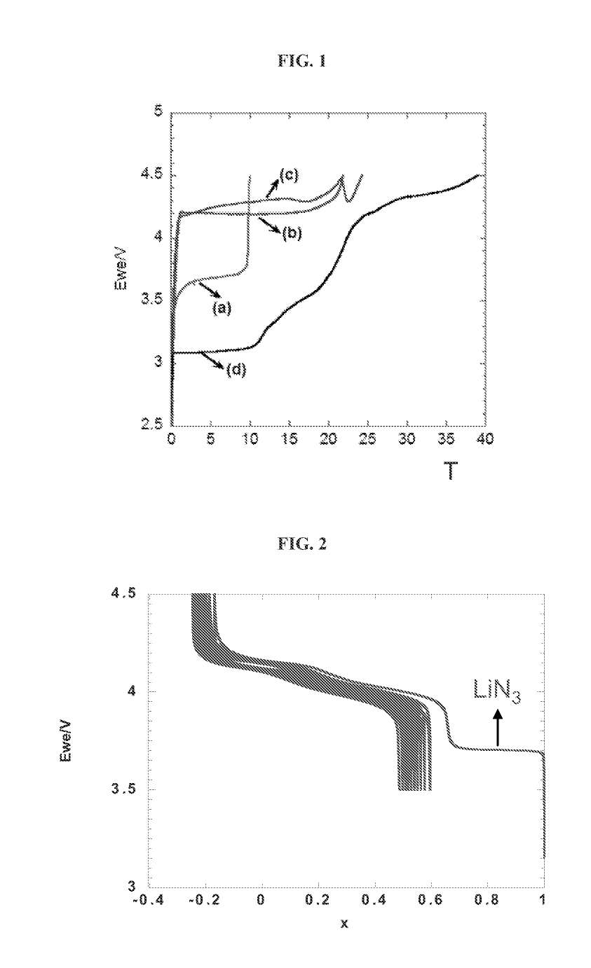

A constant current of 28 μA was applied to the cell between the working electrode and the counterelectrode, said current allowing the extraction of one lithium equivalent of LiMn₂O₄ spinel in ten hours. The change over time in the potential difference between the working electrode and the counterelectrode (E_{we}−E_{ce}), marked E_{we}/V in FIG. 2, was recorded. The plateau corresponding to the oxidation of LiN₃ is clearly visible at 3.7 volts, and corresponds to the addition of 20% of extra capacity for the purpose of compensating the formation of the passivating layer on the negative electrode and the parasitic reactions on the electrolyte during the first cycle. The successive cycles show that the operation of the LiMn₂O₄ material is unaffected by the initial presence of LiN₃.

### COMPARATIVE EXAMPLE 1

Lithium squarate is prepared by reaction in a water/ethanol mixture (50/50) from stoichiometric amounts of squaric acid (dihydroxycyclobutenedione) (11.40 g) and lithium carbonate (7.388 g). The end of effervescence leaves a colorless solution, which is evaporated and dried under reduced pressure at 50° C.

100 mg of lithium squarate Li₂C₄O₄ mixed with 30 mg of Ketjen Black 600® were ground together in a mortar for 5 minutes to give a homogeneous mixture.

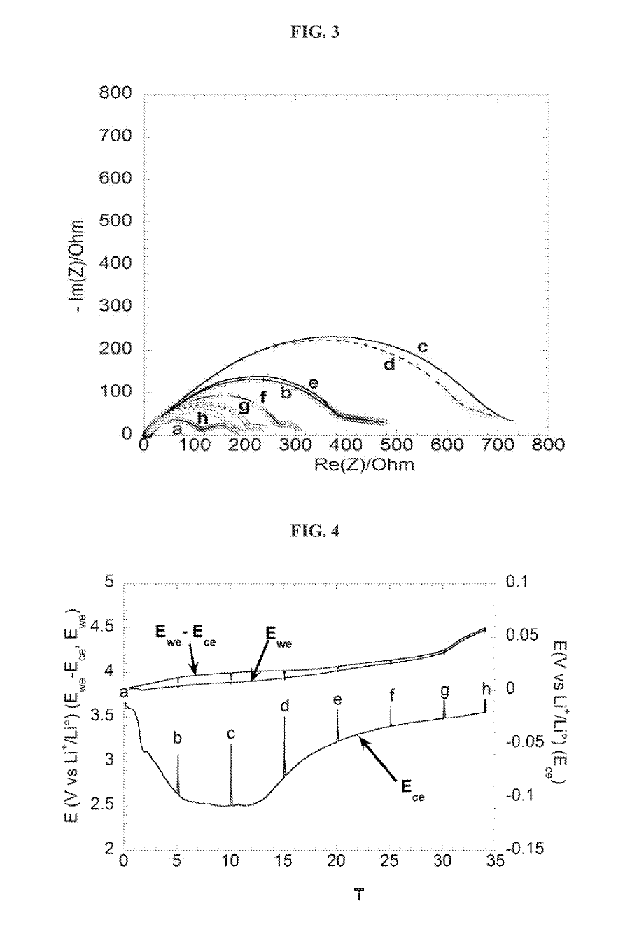

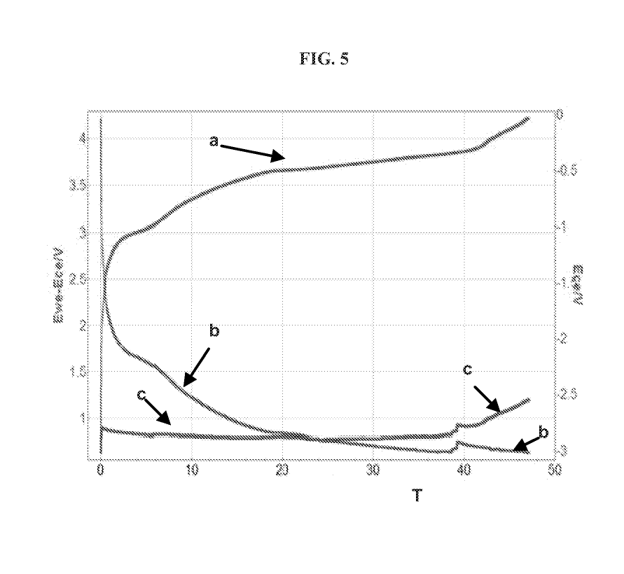

A Swagetok® electrochemical cell similar to that of example 1 was produced, with a working electrode consisting of 10 mg of the Li₂C₄O₄+carbon mixture. A constant current was applied to the cell (93 μA) between the working electrode We and the counterelectrode Ce, calculated so as to allow the extraction of two lithium equivalents of the Li₂C₄O₄+carbon mixture in thirty five hours. Various measurements were carried out in the same time, and the results are shown in FIGS. 3 and 4.

FIG. 3 shows the variation in the imaginary impedance [Im(Z)/ohm] of the counterelectrode CE as a function of the real capacity [Re(Z)/ohm], determined every 5 hours (from the curve “a” at T=0, to the curve “h” at T=35 hours).

FIG. 4 shows the change over time T (in hours):
in the potential difference between the working electrode and the reference electrode (curve labeled E_{we}) and in the potential difference between the working electrode and the counterelectrode (curve labeled E_{we}−E_{ce}), by reference to the left-hand ordinate scale;
the potential difference between the counterelectrode and the reference electrode on the right-hand ordinate scale (curve labeled E_{ce}), by reference to the right-hand ordinate scale. The impedances deduced from FIG. 4 have been plotted on the curve E_{ce}.

FIGS. 3 and 4 show that the counterelectrode undergoes polarization during the electrochemical reaction and that its impedance (labels a [symbol] d) increases by a factor of 7. These measurements are in agreement with the deposition, on the negative counterelectrode, of the reduction products of a species which is soluble in the electrolyte, namely the anion radical C₄O₄−.. The result is that the compound Li₂C₄O₄ gives soluble anion radicals C₄O₄−., and therefore cannot be used in practice as a sacrificial salt.

The same is true of other oxocarbons, especially Li₂C₅O₅ and Li₂C₆O₆, which under the same conditions, give rise, respectively, to soluble anions C₅O₅−. and C₆O₆−..

### EXAMPLE 7

A “sodium-ion” battery was constructed by assembling a negative electrode, an electrolyte containing a sodium salt, and a positive electrode containing an additive according to the invention.

The negative electrode is composed of a current collector made of aluminum (a metal which does not form an alloy with sodium), having a thickness of 25 μm.

The electrolyte is a film having a thickness of 13 μm and is composed of a solid solution of 413 mg of Na[CF₃SO₂)₂N] in 1.2 g of a commercial poly(ethylene oxide) PEO with an average mass of 5×10⁶ daltons, such that the “oxygen atoms of the polyether'sodium ions” ratio is 20/1. The film of electrolyte is obtained from a solution containing 95 weight % of acetonitrile and 5 weight % of “PEO+sodium salt” mixture, said solution being poured directly onto the current collector forming the negative electrode, and then dried.

The positive electrode is a film of composite material on an aluminum current collector. The composite material is a mixture of 45 weight % of Na₂FePO₄F, 15 weight % of commercial NaN₃, 10 weight % of Ketjen Black 600® carbon black, and 30 weight % of a solid solution of Na[CF₃SO₂)₂N] in a poly(ethylene oxide) PEO similar to that which makes up the electrolyte. The constituents of the composite material are suspended in acetonitrile, and the suspension is homogenized on a roll mill for 24 hours, then expanded by means of a template onto a film of aluminum having a thickness of 25 μm (which forms the negative electrode), in an amount such that evaporation of the acetonitrile gives a dense layer having a thickness of 80 μm.

The negative electrode carrying the film of electrolyte and the positive electrode are assembled by lamination at 80° C., The resulting battery is dried under reduced pressure at 70° C. and enclosed in the absence of air in a “metalloplastic” casing, which is equipped with inlets and outlets for supply of positive and negative currents, and also with means allowing the evacuation of the gases formed during the operation of the battery. The casing is subsequently sealed.

For the 1st operating cycle:
the enclosure enclosing the battery is placed under reduced pressure, the battery is held at 70° C., and charging takes place with a current density of 100 μA·cm⁻² up to the high cut-off potential of 3.8 V, which corresponds to a capacity of 9.8 mAh·cm⁻². The nitrogen formed during the first charge is evacuated, and the enclosure is resealed.
the battery is discharged under the same current density of 100 μA·cm⁻² between 3.8 and 2 V. The superficial capacity measured is 4 mAh·cm⁻², which corresponds, taking into account the mass of Li and Fe fluorophosphates used (11 mg/cm²), to a mass capacity of 86% of the expected theoretical capacity (which is 128 mAh·g⁻¹) of the mass of Na₂FePO₄F.

The battery was subjected to 50 operating cycles with a current density of 100 μA·cm⁻², and was then disassembled under argon in a glovebox. The presence of a film of sodium was noted on the aluminum collector forming the negative electrode, this overcapacity coming from the decomposition of the sodium azide.

### EXAMPLE 8

A “sodium/sulfur” battery was assembled, comprising the following elements:
a molybdenum steel container with an internal diameter of 4 cm;
a beta-alumina (11 Al₂O₃, 1.1 Na₂O) tube with an outer diameter of 1.5 cm, placed inside the steel container, with the container and tube being concentric;
in the annular space between the container and the tube: a compacted mixture consisting of 55 weight % of dry commercial sodium tetrasuifide Na₂S₄, 35 weight % of sodium azide NaN₃, and 10 weight % of carbon fibers having an average diameter of 3 ptm and a length of 5 mm, said compacted mixture forming the positive electrode;
in the beta-alumina tube: steel wool degreased beforehand and treated with a hydrogen-nitrogen mixture (10% H₂) at 600° C. for an hour, the steel wool occupying≈10% of the internal volume of the tube, said steel wool forming the negative electrode.

The battery is made impervious by the fitting of a molybdenum steel cover, comprising a tube equipped with a valve, and is connected to a primary vacuum pump. It is heated to 300° C. with a temperature increase of ≈1° C. per minute, so as to cause the gradual departure of the nitrogen, to form a liquid mixture of Na₂S₃ and Na₂S₂ in the annular space, said mixture forming the cathode material. The battery is subsequently charged at 330° C. under a current of 10 mA·cm⁻² to a potential of 2.8 V, which corresponds to the extraction of all of the sodium from the cathode material. This low initial current density allows the full electrochemical activity of the mixture of Na₂S₃ and Na₂S₂ to be accessed, this mixture being partially solid owing to the presence of Na₂S₂, which has a low solubility in molten Na₂S₃ at 330° C.

The battery can be cycled between 2.8 V and 2.1 volts (S₈ [symbol] Na₂S₃) with a current density of 200 mA·cm⁻² with no perceptible loss in capacity over 600 cycles.

### EXAMPLE 9

An electrode was produced as follows: A suspension in N-methyl-pyrrolidinone (NMP) was prepared of lithium azide, carbon SP®, hetatype manganese dioxide, and poly(vinylidene fluoride), in ratios by mass of 0.36/0.16/0,27/0.21. Following dissolution of the polymer, the viscous suspension obtained was poured onto a glass plate, and the solvent was then evaporated. The film was detached from the glass.

A lithium/air battery was assembled, consisting of a lithium negative electrode, a liquid electrolyte composed of a 1M solution of LiPF₆ in a mixture in equal masses of ethylene carbonate and methyl carbonate, and a portion of the film obtained after separation from the glass plate, as positive electrode.

FIG. 5 shows, for the first oxidation cycle, the voltage (in volts) as a function of time (in hours), for two samples cut from the film obtained above. The capacity observed is that expected from the decomposition of the sacrificial salt.

The curve (a) shows the potential of the positive electrode where the oxidation of the sacrificial salt takes place, as a function of time, the current of 112 μA·cm⁻² being calculated for extraction of one lithium equivalent in 10 hours.

The curve (b) shows the curve of the first discharge after oxidation of the sacrificial salt.

The curve (c) shows the potential of the lithium counterelectrode.

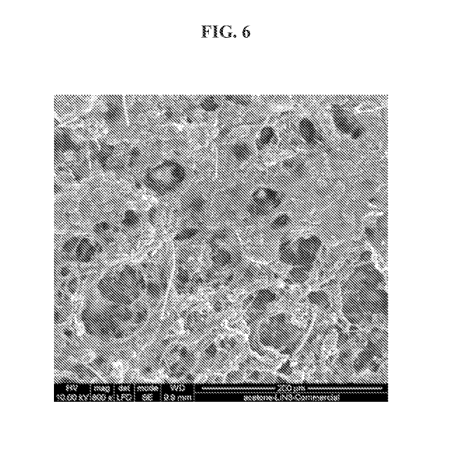

FIG. 6 is a micrograph image obtained by scanning electron microscopy, which shows the positive-electrode material after cychng. It shows the pores which are formed on decomposition of the sacrificial salt, said pores allowing oxygen to penetrate into the battery and to gain access to the lithium negative electrode.

1. A method for producing a battery which operates by circulation of ions A⁺ selected from Li⁺ and Na⁺, said method comprising;
assembling a negative electrode, a positive electrode, and an electrolyte, and
then subjecting the assembly to a first charge at the operating temperature of the battery, wherein:
the electrolyte is a material in which the cations A⁺ are mobile, selected from the group consisting of ceramics and solutions of a salt of A⁺ in a polar liquid, a polymer, and mixtures thereof;
the active material of the negative electrode is a material which possesses a redox couple whose potential is from 0 V to 1.6 V relative to the A⁺/A⁰ couple, selected from the group consisting of metal A, alloys and intermetallic compounds of the metal A, and materials capable of reversibly liberating cations A;
the active material of the positive electrode is a material which possesses a redox couple whose potential is greater than that of the couple of the negative electrode, and which is capable, reversibly, either of inserting cations A⁺ or of reacting with the cations A⁺,
wherein the positive electrode used at assembly is composed of a composite electrode material and a current collector, said composite material having said positive-electrode active material and at least one “sacrificial salt” whose cation E⁺ is selected from the group consisting of Li⁺, Na⁺, K⁺ and onium cations, and whose anion is a redox anion selected from the croup consisting of azide anions, ketocarboxylate anions, and hydrazide anions, optionally in polymeric form, said sacrificial salt having a redox couple at a potential greater than the potential of the negative-electrode active material redox couple.

2. The method of claim 1, wherein the potential of the redox couple of the sacrificial salt is in the range from 2.0 V to 4.6 V.

3. The method of claim 1, wherein the sacrificial salt is a salt which is liquid at standard temperature or at a temperature of less than 100° C.

4. The method of claim 3, wherein the onium cation is selected from the group consisting of alkylmethylimidazolium, alkylmethylpyrrolidinium, and alkyltrimethylammonium cations in which the alkyl group has from 2 to 8 carbon atoms.

5. The method of claim 1, wherein the electrolyte used at assembly comprises at least one salt of A in solution in a solvent,

6. The method of claim 5, wherein
the salt of A⁺ of the electrolyte is selected from salts of an anion corresponding to one of the following formulae selected from the group consisting of: ClO₄⁻, BF₄⁻, PF₆⁻, AsF₆⁻, SbF₆⁻, SCN⁻, R_{F}SO₃⁻, [(R_{F}SO₂)NSO₂R′_{F}]⁻, [(R_{F}SO₂)C(Y)SO₂R_{F}′]⁻ in which Y is CN or SO₂R_{F}″, [R_{F}SO₂(NCN)]⁻, [R_{F}SO₂{C(CN)₂}]⁻, 2-perfluoroalkyl-4,5-dicyanoimidazole [R_{F}C₅N₄]⁻4,5-dicyano-1,2,3-triazole [C₄N₅]⁻, 2,5-bis(fluorosulfonyl)-1,3,4-triazole [C₇F₂S₂O₄]⁻, and 3-cyano-5-perfluoroalkyl-1,3,4-triazote [R_{F}C₃N₄]⁻, where R_{F}, R_{F}′, and R_{F}″ are alkyl groups in which at least 60% of the hydrogen atoms are replaced by fluorine atoms;
the solvent of the electrolyte is a liquid solvent optionally gelled by addition of a polymer, or a polymeric solvent optionally plasticized by a liquid solvent,

7. The method of claim 5, wherein the positive electrode used at assembly is composed of a current collector which carries a composite electrode material comprising from 5 to 95 weight % of positive-electrode active material, from 0.1 to 30 weight % of an electron-conducting agent, from 5 to 70 weight % of at least one sacrificial salt, and from 0 to 25 weight % of a binder.

8. The method of claim 7, for producing a battery in which A is Li, wherein the active material of the positive electrode is a material capable of reversibly inserting lithium ions, selected from:
transition metal chalcogenides, more particularly oxides LiₓT^{a}O₂ in which 0≦x≦1 and T^{a} represents at least one element selected from Co, Ni, and Mn, a part of which may be replaced by Mg or Al;
phosphates of olivine structure LiₓT^{b}PO₄, 0≦x≦1, in which T^{b} represents at least one element selected from either one of Fe and Mn, a part of which may be replaced by Co, Ni or Mg;
silicates Li₂₋ₓT^{c}SiO₄ and fluorophosphates LiₓT^{c}PO₄F, in which T^{c} represents at least one element selected from the group consisting of Fe, Mn, Co, Ni, and Ti, a part of which may be replaced by Mg or Al;
fluorophosphates LiₓT^{d}SO₄F in which T^{d} represents at least one element selected from the group consisting of Fe, Mn, Co, and Ni, a part of which may be replaced by Mg and a part of the sulfate groups SO₄²⁻ of which may be replaced by the isosteric and iso-charge group PO₃F²⁻;
polysulfides Li₂Sₙ, 1≦n≦6, and lithium salts of dimercaptothiadiazole and of dimercaptooxazole.

9. The method of claim 5, for producing a battery in which A is Li, wherein the positive electrode used at assembly comprises from 5 to 95 weight % of sacrificial salt, from 1% to 60% of carbon, and from 0 to 20 weight % of MnO₂.

10. The method of claim 7, for producing a battery in which A is Na, wherein the active material of the positive electrode is a material capable of reversibly inserting lithium ions, selected from:
the lamellar fluorophosphates Na₂TPO₄F in which T represents a divalent element selected from the group consisting of Fe, Mn, Co, and Ni, which may be replaced partially by Mg or Zn,
fluorosulfates NaT′SO₄F in which T′ represents at least one element selected from the group consisting of Fe, Mn, Co, and Ni, a part of which is optionally replaced by Mg, and a part of the sulfate groups SO₄²⁻ of which is optionally replaced by the isosteric and iso-charge group PO₃F²⁻;
polysulfides Na₂Sₙ (1≦n≦6), and sodium salts of dimercaptothiadiazole and of dimercaptooxazole;
dithiocarbamates Na[CS₂NR′R″] in which each of the groups R′ and R″ represents a methyl, ethyl, or propyl radical, or else R′ and R″ form a ring.

11. The method of claim 1, for producing a battery in which A is Li, wherein the negative electrode used at assembly is composed of a current collector which carries a composite electrode material comprising a negative-electrode active material, optionally an electron-conducting agent, and optionally a binder, said negative-electrode active material being selected from the group consisting of carbons, natural or artificial graphites, lithium dicarboxylates, alloys of lithium with Si or Sn, intermetallic lithium compounds, optionally Mg-doped lithium titanate Li₄Ti₅O₁₂, molybdenum dioxide, and tungsten dioxide.

12. The method of claim 1, for producing a battery in which A is Na, wherein the negative electrode used at assembly is composed of a current collector which carries a composite electrode material comprising a negative-electrode active material, optionally an electron-conducting agent, and optionally a binder, said negative-electrode active material being selected from the group consisting of carbons, natural or artificial graphites, sodium dicarboxylates, sodium ferrite NaₓFeO₂, sodium aluminum titanates NaₓTi_{1-z}Al_{z}O₂ (0≦x≦1, 0≦z≦0.4) of lamellar structure, and alloys of sodium with Sn or Pb.

13. The method of claim 7, wherein the electron-conducting agent is a carbon material selected from the group consisting of carbon blacks, acetylene blacks, natural or synthetic graphites, and carbon nanotubes.

14. The method of claim 1, wherein the electrolyte is a ceramic selected from the group consisting of β-alumina, β″-alumina, phosphosilicates of Nasicon structure, and glasses based on Na₂O and on at least one network-forming oxide selected from the group consisting of SiO₂, B₂O₃, and P₂O₅,

15. The method of claim 14, wherein the positive electrode used at assembly comprises a sodium salt in solution in a liquid or polymeric solvent, said salt being selected from the group consisting of sodium chloroaluminate NaAlCl₄ and sodium dithiocarbamates Na[CS₂NR′R″] in which each of the groups R′ and R″ represents a methyl, ethyl, or propyl radical, or else R′ and R″ together form a ring.

16. The method of claim 11, wherein the electron-conducting agent is a carbon material selected from the group consisting of carbon blacks, acetylene blacks, natural or synthetic graphites, and carbon nanotubes.

17. The method of claim 12, wherein the electron-conducting agent is a carbon material selected from the group consisting of carbon blacks, acetylene blacks, natural or synthetic graphites, and carbon nanotubes.
